(19) United States
(12) Patent Application Publication
(10) Pub. No.: US 2020/0310012 A1
(43) Pub. Date: Oct. 1, 2020

(54) OPTICAL ELEMENT AND DISPLAY DEVICE

(71) Applicant: CM VISUAL TECHNOLOGY CORPORATION, Tainan City (TW)

(72) Inventors: Hsin-Wen CHANG, Tainan City (TW); Kuo-Chang YU, Tainan City (TW)

(21) Appl. No.: 16/827,791

(22) Filed: Mar. 24, 2020

(30) Foreign Application Priority Data
Mar. 26, 2019 (TW) 108110478

(51) Int. Cl. G02B 5/18

(52) U.S. Cl. CPC G02B 5/1866

(57) ABSTRACT

The invention relates to an optical element disposed on a light source. The optical element includes a first medium, a second medium and a light deflecting structure. The second medium is formed on the first medium. The light deflecting structure is formed on the interface between the first medium and the second medium. The relationship between the optical element and the light emitted by the light source satisfies the formula: 0<|W_{B}−W_{A}|/W_{ref}<10, wherein W_{A} is an image broadening width obtained under the circumstances of the light passing through the optical element with the first medium as the light incident side; W_{B} is an image broadening width obtained under the circumstances of the light passing through the optical element with the second medium as the light incident side; and W_{ref} is a width obtained under the circumstances of the light not passing through the optical element.

This application claims the benefit of Taiwan application Serial No. 108110478, filed Mar. 26, 2019, the subject matter of which is incorporated herein by reference in its entirety.

### BACKGROUND OF THE INVENTION

### Field of the Invention

The invention relates in general to an optical element and a display device including the same, and more particularly to a light-controlled optical element and a display device using the same.

### Description of the Related Art

Over the years, the display has been widely used in various electronic products, such as personal computers, laptops, digital cameras, smart phones, tablets, and LCD TVs. The optical film is an essential element of the display for solving the issues which may possibly arise due to the design of the display. The optical film can be independently formed as a film element or can be coated on other elements in the form of a single- or multi-layer coating to improve the display quality through the physical features of the film or the coating material. Ordinary functions of the optical film include reducing the light leakage of the LCD in a dark state, greatly increasing the contrast and color saturation of the image within a certain viewing angle, and solving some of the grayscale inversion problems.

### SUMMARY OF THE INVENTION

According to an embodiment of the present invention, an optical film and a display device using the same are provided. The said optical film can improve the readability of the display content.

According to another embodiment of the present invention, an optical film and a display device using the same are provided. The said optical film can solve the problems of the display modules including narrow viewing angle, color shift or light leakage.

According to an alternate embodiment of the present invention, an optical film and a display device using the same are provided. The said optical film can solve blurred frames caused by the spreading out of incident light after passing through the optical film.

According to an implementation of the invention, the optical element is disposed on a light source which is configured to emit a light. The optical element includes a first medium, a second medium formed on the first medium, and a light deflecting structure formed on an interface between the first medium and the second medium. The relationship between the optical element and the light emitted by the light source satisfies the following formula (1):

0<|W_{B}−W_{A}|/W_{ref}<10 (1)

wherein W_{A} is an image broadening width measured under the circumstances of the light passing through the optical element with the first medium as the light incident side; W_{B} is an image broadening width measured under the circumstances of the light passing through the optical element with the second medium as the light incident side; and W_{ref} is a width measured under the circumstances of the light not passing through the optical element.

According to an implementation of the invention, the optical element is disposed on the light source, and the optical element includes a first medium, a second medium formed on the first medium, and a light deflecting structure formed on the interface between the first medium and the second medium. The first medium has a first refractivity, the second medium has a second refractivity. A light emitted by the light source sequentially passes through the first medium and the second medium, and the first refractivity is less than the second refractivity.

According to an implementation of the invention, the display device includes a display configured to display an image, and an optical element disposed on the display. The optical element includes a first medium, a second medium formed on the first medium, and an interface between the first medium and the second medium includes a light deflecting structure. The first medium has a first refractivity, the second medium has a second refractivity. A light for forming the image sequentially passes through the first medium and the second medium, and the first refractivity is less than the second refractivity.

According to an implementation of the invention, the display device includes a display configured to display an image, and an optical element disposed on the display. The optical element includes a first medium, a second medium formed on the first medium, an interface between the first medium and the second medium includes a light deflecting structure, and a protection layer formed on the second medium. The first medium has a first refractivity, the second medium has a second refractivity, and the first refractivity is less than the second refractivity.

The above and other aspects of the invention will become better understood with regards to the following detailed description of the preferred but non-limiting embodiment(s). The following description is made with reference to the accompanying drawings.

### BRIEF DESCRIPTION OF THE DRAWINGS

FIGS. 1A to 1D are cross-sectional views of an optical element according to some embodiments of the invention.

FIG. 2 is a schematic diagram depicting the relationship between the light intensity and position of a light source.

FIG. 3 is a schematic diagram of an optical element and a display according to an embodiment of the invention.

FIG. 4 is a schematic diagram of an optical element according to an embodiment of the invention.

FIGS. 5A to 5B are schematic diagrams depicting the relationship between the light intensity and position obtained from an image energy distribution according to an embodiment of the invention.

### DETAILED DESCRIPTION OF THE INVENTION

For the object, technical features and advantages of the present invention to be more easily understood by anyone ordinary skilled in the technology field, a number of exemplary embodiments are disclosed below with detailed descriptions and accompanying drawings. The embodiments of the invention provide many inventive concepts that can be widely used various backgrounds. The exemplary embodiments disclosed in the present specification are for explaining the manufacturing method and use of the invention, not for limiting the scope of protection of the invention.

It is noted that the present specification provides various embodiments or examples for realizing different features of the invention. The following disclosure of the present specification relates to the exemplary embodiments of each component and specific examples of component arrangement to simplify the description of the invention. However, these specific examples are not for limiting the invention. For example, in the present specification, the disclosure that the first feature is formed on or above the second feature also includes the embodiments in which the first feature and the second feature contact each other directly. Such disclosure also includes the embodiments in which an additional feature is formed between the first feature and the second feature and causes the first feature and the second feature not to contact each other directly.

According to the common practice, the illustration of each feature is not based on real scale. Conversely, to simplify the drawing, the scale of each feature can be arbitrarily enlarged or reduced. Moreover, the present specification may use the same reference symbols and/or designations in different examples for the purpose of simplification and clearness, not for limiting the relationship between each embodiment and/or the structure appearance.

Readability of the display content has been viewed as an important quality standard of the display. It is a common practice in the industry to improve the image quality of a display device by utilizing an optical film. For example, the optical film with diffractive structures can be used to solve the problems of the display module such as narrow viewing angle, color shift or light leakage. However, those optical films may cause blurred frames under some circumstances.

Through researches, the inventors of the invention found that the expansion level caused by the light passing through the optical film is one of the factors that affects the display quality of an image, and the problem of blurred frames can be solved by controlling the expansion level of the optical film showed on the display. More specifically, the control of the image expansion ratio obtained from both sides of the optical film (the front side and the rear side) helps to solve the problem of blurred frames. Below, an optical element with diffractive structure and a display device using the same are provided in the present application, and the relationship between the light expansion levels obtained when the optical element is adhered to the display with the front side and when the optical element is adhered to the display with the rear side is disclosed. In ordinary researches, the relationship between the expansion level generated when the light passes through the optical element along single direction and the image quality control is studied. In the present example, the expansion levels generated by the light passing through the optical element along two opposite directions and their correspondence relationship are further studied to maintain a suitable perceived resolution of the display.

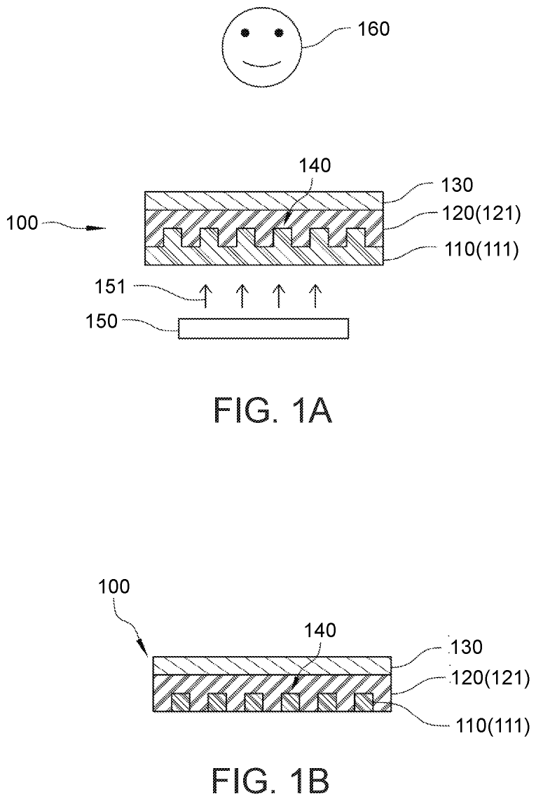

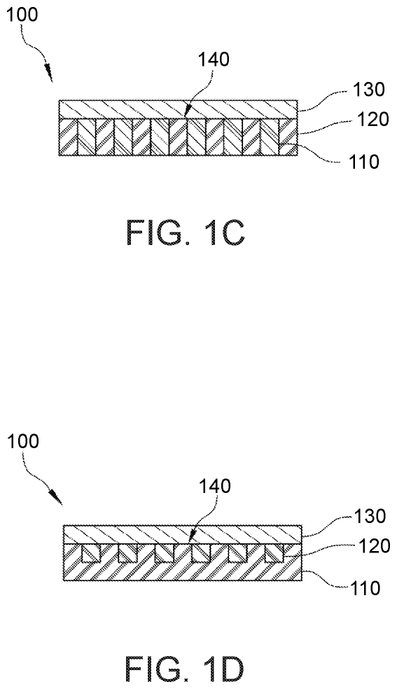

FIGS. 1A˜1D are cross-sectional views of an optical element 100 according to some embodiments of the invention. According to these embodiments, the optical element 100 is disposed on the light source 150, and includes a first medium 110, a second medium 120 and a protection layer 130, wherein an interface between the first medium 110 and the second medium 120 comprises a light deflecting structure 140. The light deflecting structure 140 is provided to modulate the phase or amplitude of an incident light. When a light 151 emitted by the light source 150 passes through the optical element 100, the light 151 will be seen by a viewer 160 after being expanded by the light deflecting structure 140.

The optical element 100 can be an optical film or an optical sheet. With the light deflecting structure 140 of the optical element 100, the light 151 emitted by the light source 150 can be split and/or deflected into several beams travelling towards different directions to regulate the distribution of the light. In some embodiments, the optical element 100 can be a stack structure formed of more than two film layers. In some embodiments, the light deflecting structure 140 can be a diffraction structure, which is designed according to the diffraction principles and the compensation effects needed. For example, the light deflecting structure 140 can be a diffraction grating with micro-structures, such as ridges or rulings, on the surface. In other examples, the light deflecting structure 140 can be a staggered distribution of bright bands and dark bands.

In some embodiments, the light deflecting structure 140 is formed on the interface between the first medium 110 and the second medium 120. For example, the 3D structure on the surfaces of the first medium 110 and the second medium 120 are corresponding to each other, such that the light deflecting structure 140 can be formed on the interface between the first medium 110 and the second medium 120. In some embodiments, the morphology on the interface of the first medium 110 and that of the second medium 120 are complementary with each other, such that the light deflecting structure 140 can be formed on the interface between the first medium 110 and the second medium 120.

In some embodiments, the light deflecting structure 140 can be a grating structure with a constant spacing, and the spacing is preferably in a range of 0.2 μm to 10 μm. In some other embodiments, the light deflecting structure 140 can be a grating structure with a non-constant spacing, for example, the grating structure with various spaces between each grating (a multiple-spacing) or a gradient spacing, wherein the spacing of the grating structure is in a range of 0.3 μm to 50 μm. In the embodiment in which the spacing of the grating structure is not constant, the variation of the grating spacing is in a range of 0.4 μm to 10 μm; in other embodiments, the variation of the grating spacing is at least 1% of the largest grating spacing or less than 90% of the largest grating spacing.

In some embodiments, the light deflecting structure 140 can be arranged continuously. Specifically, the light deflecting structure 140 can be arranged continuously all over the optical element 100. That is, the light deflecting structure 140 can cover 100% of the area of the optical element 10. In some embodiments, the light deflecting area with the light deflecting structure 140 can be arranged discontinuously. Specifically, the light deflecting area with the light deflecting structure 140 can be arranged between ordinary areas (the area without the light deflecting structure, which can also be referred as the non-light-deflecting area). That is, a plurality of light deflecting areas are separated by ordinary areas (the non-light-deflecting area). In these embodiments, the light deflecting area can cover 30-95% of the area of the optical element 100.

The optical element 100 can be formed by a suitable manufacturing process. For example, firstly, the first medium 110 is formed on a substrate (not illustrated); next, the second medium 120 is formed on the first medium 110; then, the protection layer 130 is formed on the second medium 120; lastly, the substrate is removed to complete the manufacturing of the optical element 100. In some other embodiments, the protection layer 130 is used as the substrate, the second medium 120 is formed on the protection layer 130, and the first medium 110 is formed on the second medium 120 to complete the manufacturing of the optical element 100. The light deflecting structure 140 can be formed at the same time as the first medium 110 or the second medium 120. In other embodiments, the light deflecting structure 140 can be formed by a manufacturing process such as photolithography, engraving, embossing, transferring or printing.

It should be understood that the first medium 110 and/or the second medium 120 can be a single film layer. For example, as indicated in FIG. 1A, the first medium 110 and the second medium 120 are the material that spread over the surface of the substrate or the protection layer. In the present embodiment, the morphology of the film layer 111 formed of the first medium 110 is complementary with the morphology of the film layer 121 formed of the second medium 120. In other embodiments, the first medium 110 and/or the second medium 120 can be multiple structures separated from each other. For example, as indicated in FIG. 1C, the first medium 110 and the second medium 120 independently include multiple discontinuous structures 110a/120a. In the present embodiment, the structures of the first medium 110 and the second medium 120 are arranged in alternating pattern.

The first medium 110 and the second medium 120 can be formed of one material or a composite material. In an embodiment, the first medium 110 and the second medium 120 may independently be a viscoelastic or elastic adhesive, such as pressure sensitive adhesive (PSA), rubber-based adhesive and polysiloxane-based adhesive. Examples of viscoelastic or elastic adhesives include an elastic polyurethane-based adhesive or a polysiloxane-based adhesive, a styrene-block-copolymer-based adhesive, a (meth) acrylic-block-copolymer-based adhesive, a polyvinyl ether-based adhesive, a polyolefin-based adhesive, and a polymethacrylate-based adhesive.

In another embodiment, the first medium 110 and the second medium 120 can independently be a crosslinked resin layer or a soluble resin layer. Examples of the material of the crosslinked resin layer may include thermosetting resin or UV curing resin formed of such as (methyl) acrylic, urethane, (meth) acrylic urethane, epoxy, or polyoxyn. In a specific embodiment, both of the first medium 110 and the second medium 120 are crosslinked resin layers.

In an embodiment, the first medium 110 can be an adhesive for binding the optical element 100 to the display. In an embodiment where the first medium 110 is not an adhesive, the optical element 100 may further include an adhesion layer (not illustrated) for binding the optical element 100 to the light emitting side of the display.

In some embodiments, the first refractivity of the first medium 110 is different from the second refractivity of the second medium 120. In some embodiments, the first refractivity of the first medium 110 is less than the second refractivity of the second medium 120. For example, the first refractivity is in a range of 1.2 to 1.8, and the second refractivity is in a range of 1.4 to 2.

In an embodiment, the first medium 110 and the second medium 120 may independently contain fillers such as inorganic nanoparticles or light diffusing particles for adjusting the refractivity of the layer. Under such circumstances, the refractivity of the first medium 110 and the second medium 120 is defined as the average refractivity of the composite material. Examples of the suitable nano-materials may include inorganic nanoparticles or organic nanoparticles, such as metal dioxide nanoparticles, zirconia, titanium dioxide, aluminum oxide, tin oxide, silicon dioxide and polymethyl methacrylate (PMMA) nanoparticles.

In an embodiment, the light transmittance of the first medium 110 and the second medium 120 is independently more than 80%. In an exemplary embodiment, the light transmittance of the first medium 110 and the second medium 120 is independently more than 90%. In another embodiment, the light transmittance of the first medium 110 and the second medium 120 is independently less than 70%. In an exemplary embodiment, the light transmittance of the first medium 110 and the second medium 120 is independently less than 50% to block part of the undesired light. In practical application, the material whose light transmittance is greater than 90% can be used in conjunction with the material whose light transmittance is less than 50%.

Based on the factors such as the design of the light deflecting structure 140, the materials of the first medium 110 and the second medium 120 and/or the area percentage occupied by the light deflecting structure 140, the optical element 100 may have a predetermined deflection effect to the incident light. In an embodiment, under the circumstances of the light passing through the optical element 100 (light exits the optical element 100 after entering into it), in the transmitted light, the ratio of the light intensity of the zero-order deflective light (the direction of the transmitted light is the same as the direction of the incident light) to the light intensity of the non-zero-order deflective light (the direction of the transmitted light is different from the direction of the incident light) is less than 100. In an embodiment, under the circumstances of the incident light vertically entering the optical element 100, in the transmitted light, the ratio of the light intensity of the zero-order deflective light to the light intensity of the deflective light whose deflection angle is greater than 15° (the angle between the direction of the transmitted light and the direction of the incident light is greater than ±15°) is less than 100. The same effect can be achieved if the ordinary area (or the light non-deflecting area) is a non-translucent area which almost does not allow the light to pass through.

The light source 150 can be a point light source or a surface light source, and preferably the characteristic dimensions of the light source can be clearly defined. The characteristic dimension may include but not limited to 1D characteristic dimension or 2D characteristic dimension. For example, the 1D characteristic dimension can be length, width, diameter or diagonal. The 2D characteristic dimension may include but not limited to area. For example, the light source 150 can be a display, the pixel (or sub-pixel) of a display, a backlight module or a light box. The type of display includes but is not limited to liquid crystal display (LCD), plasma display panel (PDP), organic light emitting diode display (OLED display), small pitch display (Mini-LED display), micro-LED display, e-paper display or other types of display for displaying image. Besides, the display listed above can be combined with other elements. For example, the display can be combined with a touch element to form a touch panel. The optical element 100 can be integrated into the display or can be disposed on the light emitting side of the display. The optical element 100 can also be integrated into other elements (such as anti-reflection film or touch panel) or can be disposed on the light emitting side of the display.

As used herein, the terms “broadening” or “expansion” of the light refers to the phenomenon that light emitted from the light source being widened or spread out according to the mechanisms of diffraction, deflection or scattering after the light passes through the optical element 100. According to an embodiment, the “broadening level” or “expansion level” of the light relates to the changes of the distribution ranges obtained after the light passed through the optical element 100 by taking the original distribution of the light emitted from the light source as a reference. In another embodiment, the “broadening level” or “expansion level” of the light relates to the relationship between the distribution ranges obtained when the light passes through the optical element 100 along a first direction and when the light passes through the optical element 100 along a second direction. Under a specific implementation, the first direction and the second direction are two opposite directions.

According to an embodiment, the quantification of the “broadening level” or “expansion level” is based on the original characteristic dimension of the light source and the characteristic dimension of the light after passing through the optical element 100. In an embodiment, the “broadening level” or “expansion level” relates to the relationship between the characteristic dimension obtained when the light does not pass through the optical element 100 and the characteristic dimension obtained when the light of the light source passes through the optical element 100. In another embodiment, the “broadening level” or “expansion level” relates to the relationship between the characteristic dimension obtained when the light passes through the optical element 100 along a first direction and the characteristic dimension obtained when the light passes through the optical element 100 along a second direction. In a specific embodiment, the first direction and the second direction are perpendicular to the film surface of the optical element 100 in opposite directions.

For example, in an embodiment, the “broadening level” or “expansion level” is evaluated by the ratio of the width change, wherein the ratio is of the original width obtained when the light does not pass through the optical element 100 to the broadening width obtained when the light passes through the optical element 100. In another embodiment, the “broadening level” or “expansion level” is evaluated by the ratio of the width change, wherein the ratio is of the broadening width obtained when the light passes through the optical element 100 along a direction perpendicular to the film surface to the broadening width obtained when the light passes through the optical element 100 along an inverse direction.

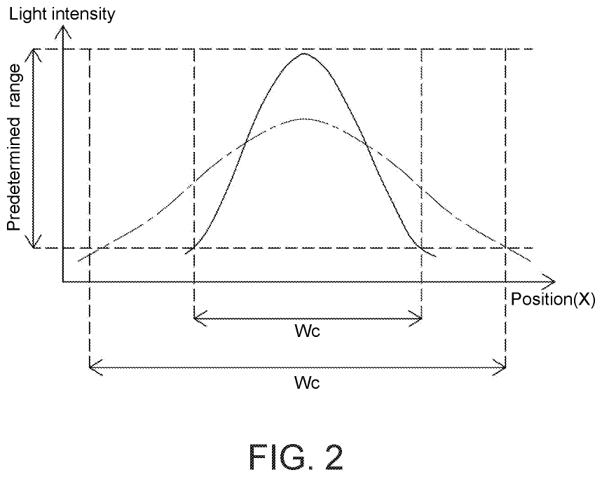

The quantification of the “broadening level” or “expansion level” is exemplified with accompanying drawings. Referring to FIG. 2, a schematic diagram showed the relationship of the light intensity vs position of a light source. The characteristic width W_{c} can be used as a reference for evaluating the “broadening level” or “expansion level”, wherein the characteristic width W_{c} is a position interval (distance) corresponding to a predetermined light intensity range. In an embodiment, the predetermined light intensity range can be a specific percentage range of light intensity, wherein the percentage of light intensity is calculated based on the maximum intensity obtained under the circumstances of the light not passing through the optical element (which is regarded as 100% light intensity). Generally, the perceptual limit of human eyes is used as the low limit of the predetermined intensity range. For example, the predetermined intensity range can be 5%˜100% or 10%˜100% of the light intensity.

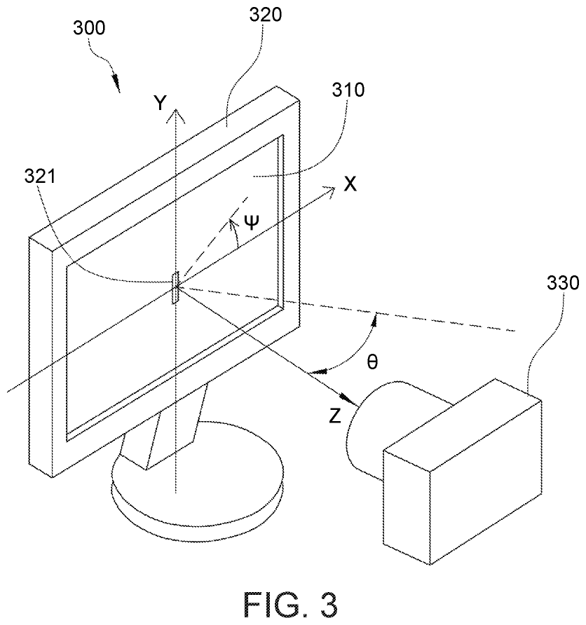

FIG. 3 is a schematic diagram of an optical element and a display according to an embodiment of the invention. Based on the principles of the spherical coordinate system, two perpendicular lines on a plane parallel to the display surface of the display 300 are defined as coordinate axes. Generally, the horizontal line directed rightward is defined as the X axis, the vertical line directed upwards is defined as the Y axis, and the axis perpendicular to the display surface of the display 300 is defined as the Z axis. Thus, the observation angle for watching the display 300 can be represented by a zenith angle θ and an azimuthal angle ψ of the spherical coordinate system. The azimuthal angle ψ is a rotation angle on the XY plane obtained by rotating anti-clockwise from the X axis to the projected vector of the observing direction on the XY plane, wherein the azimuthal angle ψ is in a range of 0° to 360°. The zenith angle θ is the angle between the observing direction and the Z-axis and is in a range of 0° to 90°. In an embodiment, the axial line parallel to the horizontal line can be defined as the X axis, the axial line parallel to the vertical line can be defined as the Y axis, and the axial line of the third dimension perpendicular to the XY plane can be defined as the Z axis.

In the present embodiment, the optical element 310 is applied to the display device 300. As indicated in FIG. 3, the display device 300 includes an optical element 310 and a display 320, wherein the optical element 310 is disposed on the light emitting side of the display 320. That is, the optical element 310 is attached on the light emitting side of the display 320 which is parallel to the XY plane. In the present embodiment, the light emitting unit 321 in the display 320 is used as a light source, the images displayed on the display 320 resulting from the light emitting unit 321 under the conditions (i)˜(iii) are respectively captured by a camera 330, wherein Condition (i): no optical element is attached on the display 320; Condition (ii): the optical element is attached on the display 320 through the front side; Condition (iii): the optical element is attached on the display 320 through the rear side. Then, the energy distribution of the captured images are analyzed, the relationship of light intensity vs position is illustrated, and a corresponding position interval (distance) is obtained based on the light intensity range of 10%˜100%, and this distance is used as a characteristic width which represents the width of the light emitting unit or the expansion width perceived by human eyes.

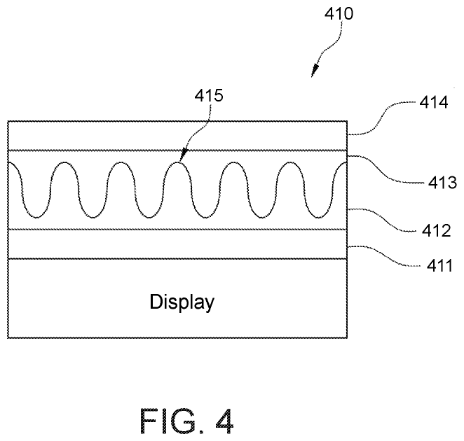

During the measurement process, the distance between the light source and the light deflecting structure of each test sample is required to be substantially the same. Referring to FIG. 4, a schematic diagram of an optical element 410 according to an embodiment of the invention is shown. For the convenience of measurement, the optical element 410 is formed as a stack structure of film layers. From bottom to top, the stack structure includes a first outer layer 411, a first layer 412 formed of the first medium, a second layer 413 formed of the second medium, a second outer layer 414, and the interface between the first layer 412 and the second layer 413 comprises a light deflecting structure 415. In an embodiment, the thicknesses of the first layer 412 and the second layer 413 are so small that can be omitted, so thicknesses of the first outer layer 411 and the second outer layer 414 are required to be the same. Adhesion layers (not illustrated) can be further included outside the first outer layer 411 and the second outer layer 414 for attaching the optical element 410 to the display 420.

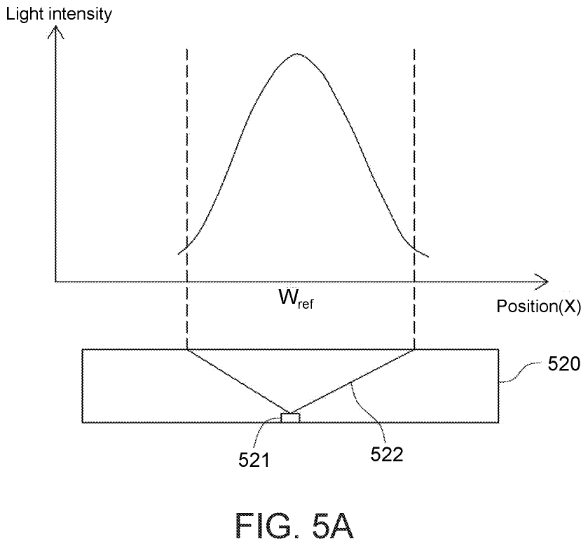

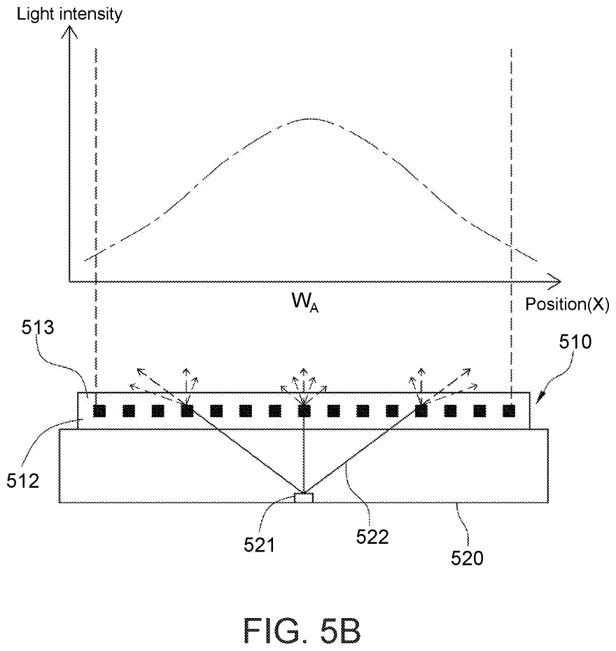

As indicated in FIG. 5A, the single sub-pixel in the display 520 is used as a light emitting unit 521, and an image is formed by the light 522 emitted from the light emitting unit 521. The relationship of light intensity vs position can be obtained according to the energy distribution of the image, wherein the width of the image is the image width W_{ref} obtained under the circumstances of the light 521 not passing through the optical element (not illustrated).

Based on the same concept stated above, and refer to FIG. 5B. When the light emitted by the light source passes through the optical element 510, the light will be expanded by the light deflecting structure to generate an expanded image. The relationship of light intensity vs position can be obtained according to the energy distribution of the expanded image. When the front side of the optical element 510 is attached on the display 520 with the first layer 512 facing to the light emitting unit 521, the light 522 passes through the optical element 510 by utilizing the first layer 512 as the light incident side, and the image broadening width of the expanded image obtained under such circumstances is W_{A}. When the rear side of the optical element 510 is attached on the display 520 with the second layer 513 facing to the light emitting unit 521, the light 522 passes through the optical element 510 by utilizing the second layer 513 as the light incident side, and the image broadening width of the expanded image obtained under such circumstances is W_{B}. The relationship between the optical element 510 and the light 522 satisfies:

0<|W_{B}−W_{A}|/W_{ref}<10 (1).

To verify the effect of the invention, the experiments are performed 6 times under the conditions of formula (1), and the results are listed in Table 1. Ex1, Ex3, Ex5 and Ex7 are the results obtained from the images captured when the camera is at a zenith angle of 0°. Ex2, Ex4, Ex6 and Ex8 are the results obtained from the images captured when the camera is at a zenith angle of 45° and an azimuthal angle of 0°. T is a spacing of the light deflecting structure. W_{ref} is an image width obtained when the light does not pass through the optical element; W_{A} is an image broadening width obtained when the light passes through the optical element with the first layer as the light incident side; W_{B} is an image broadening width obtained when the light passes through the optical element with the second layer as the light incident side.

As listed in Table 1, under the conditions of formula (1), the W_{A} (an image broadening width obtained when the light passes through the optical element with the first layer as the light incident side) is less than W_{B} (an image broadening width obtained when the light passes through the optical element with the second layer as the light incident side), the problem of the image being over-expanded can be effectively controlled.

| Ex | Ex 1 | Ex 2 | Ex 3 | Ex 4 | Ex 5 | Ex 6 | Ex 7 | Ex 8 |
|---|---|---|---|---|---|---|---|---|
| T (μm) | 2.5 | 2.5 | 4 | 4 | 6 | 6 | 14 | 14 |
| W_{ref} (μm) | 111 | 117 | 111 | 117 | 111 | 117 | 104 | 124 |
| W_{A} (μm) | 186 | 263 | 217 | 224 | 187 | 209 | 145 | 283 |
| W_{B} (μm) | 308 | 451 | 258 | 477 | 185 | 260 | 152 | 610 |
| W_{A}/W_{ref} | 1.68 | 2.25 | 1.91 | 1.95 | 1.68 | 1.79 | 1.17 | 2.72 |
| W_{B}/W_{ref} | 2.77 | 3.85 | 2.32 | 4.08 | 1.697 | 2.22 | 1.23 | 5.87 |
| W_{B}/W_{A} | 1.66 | 1.71 | 1.19 | 2.13 | 1.01 | 1.24 | 1.05 | 2.16 |
| \|W_{B} − W_{A}\|/W_{ref} | 1.10 | 1.61 | 0.37 | 2.16 | 0.02 | 0.44 | 0.06 | 3.14 |

While the invention has been described by way of example and in terms of the preferred embodiment(s), it is to be understood that the invention is not limited thereto. On the contrary, it is intended to cover various modifications and similar arrangements and processes, and the scope of the appended claims therefore should be accorded the broadest interpretation to encompass all such modifications and similar arrangements and processes.

What is claimed is:

1. An optical element disposed on a light source configured to emit light, wherein the optical element comprises:
a first medium;
a second medium formed on the first medium; and
a light deflecting structure formed on an interface between the first medium and the second medium, and the relationship between the optical element and the light satisfies the following formula (1):
0<|W_{B}−W_{A}|/W_{ref}<10 (1)
wherein W_{A} is an image broadening width obtained when the light passes through the optical element with the first medium as the light incident side; W_{B} is an image broadening width obtained when the light passes through the optical element with the second medium as the light incident side; and W_{ref} is a width obtained when the light does not pass through the optical element.

2. The optical element according to claim 1, wherein 1≤W_{A}/W_{ref}≤10.

3. The optical element according to claim 1, wherein 1≤W_{B}/W_{ref}≤10.

4. The optical element according to claim 1, further comprising:
a protection layer formed on the second medium.

5. The optical element according to claim 1, wherein the first medium has a first refractivity, the second medium has a second refractivity, and the first refractivity is less than the second refractivity.

6. The optical element according to claim 1, wherein the light deflecting structure has at least a spacing in a range of 0.3 μm to 50 μm.

7. The optical element according to claim 5, wherein 1<W_{B}/W_{A}<10.

8. The optical element according to claim 5, wherein the first refractivity is in a range of 1.2 to 1.8.

9. The optical element according to claim 5, wherein the second refractivity is in a range of 1.4 to 2.

10. A display device, comprising:
a display configured to display an image; and
an optical element disposed on the display, wherein the optical element comprises:
a first medium;
a second medium formed on the first medium; and
an interface between the first medium and the second medium comprises a light deflecting structure, wherein the relationship between the optical element and the image satisfies the formula (1)
0<|W_{B}−W_{A}|/W_{ref}<10 (1)
wherein W_{A} is an image broadening width obtained when the light passes through the optical element with the first medium as the light incident side; W_{B} is an image broadening width obtained when the light passes through the optical element with the second medium as the light incident side; and W_{ref} is a width obtained when the light does not pass through the optical element.

11. An optical element disposed on a light source, wherein the optical element comprises:
a first medium having a first refractivity;
a second medium formed on the first medium and having a second refractivity; and
a light deflecting structure formed on an interface between the first medium and the second medium, wherein a light emitted by the light source sequentially passes through the first medium and the second medium, and the first refractivity is less than the second refractivity.

12. The optical element according to claim 11, wherein the light deflecting structure has at least a spacing in a range of 0.3 μm to 50 μm.

13. The optical element according to claim 11, wherein the first refractivity is in a range of 1.2 to 1.8.

14. The optical element according to claim 11, wherein the second refractivity is in a range of 1.4 to 2.

15. The optical element according to claim 11, wherein the relationship between the optical element and the light satisfies the following formula (1)
0<|W_{B}−W_{A}|/W_{ref}<10 (1)
wherein W_{A} is an image broadening width obtained when the light passes through the optical element with the first medium as the light incident side; W_{B} is an image broadening width obtained when the light passes through the optical element with the second medium as the light incident side; and W_{ref} is a width obtained when the light does not pass through the optical element.

16. The optical element according to claim 15, wherein 1≤W_{A}/W_{ref}≤10.

17. The optical element according to claim 15, wherein 1≤W_{B}/W_{ref}≤10.

18. The optical element according to claim 15, wherein 1<W_{B}/W_{A}<10.

19. A display device, comprising:
a display configured to display an image; and
an optical element disposed on the display, wherein the optical element comprises:
a first medium having a first refractivity;
a second medium formed on the first medium and having a second refractivity; and
an interface between the first medium and the second medium comprises a light deflecting structure, wherein a light for forming the image sequentially passes through the first medium and the second medium, and the first refractivity is less than the second refractivity.

20. A display device, comprising:
a display configured to display an image; and
an optical element disposed on the display, wherein the optical element comprises:
a first medium having a first refractivity;
a second medium formed on the first medium and having a second refractivity, wherein the first refractivity is less than the second refractivity;
an interface between the first medium and the second medium comprises a light deflecting structure; and
a protection layer formed on the second medium.
